(19) United States
(12) Patent Application Publication
(10) Pub. No.: US 2014/0168574 A1
(43) Pub. Date: Jun. 19, 2014

(54) LIQUID CRYSTAL DISPLAY DEVICE

(71) Applicant: Japan Display Inc., Tokyo (JP)

(72) Inventor: Kosuke MATSUBARA, Tokyo (JP)

(73) Assignee: Japan Display Inc., Tokyo (JP)

(21) Appl. No.: 14/104,721

(22) Filed: Dec. 12, 2013

(30) Foreign Application Priority Data
Dec. 19, 2012 (JP) 2012-276433

(51) Int. Cl. G02F 1/1335

(52) U.S. Cl. CPC G02F 1/1336
USPC 349/62

(57) ABSTRACT

A liquid crystal display device includes a liquid crystal display panel and a backlight disposed on a back surface of the liquid crystal display panel. A light guide plate, a lower diffusion sheet and a lower prism sheet, are accommodated in a mold. An upper prism sheet extends over an upper surface of the mold, and bonded to the liquid crystal display panel and the mold with an adhesive. An edge of the upper prism sheet as the uppermost layer is invisible even when the screen is viewed from an oblique direction so as to prevent generation of an emission line due to the edge of the optical sheet. A sufficient bonding area is ensured between the mold and the liquid crystal display panel, and separation of the liquid crystal display panel from the mold is prevented under influence of damage.

### CLAIM OF PRIORITY

The present application claims priority from Japanese Patent Application JP 2012-276433 filed on Dec. 19, 2012, the content of which is hereby incorporated by reference into this application.

### BACKGROUND

The present invention relates to a liquid crystal display device, and more particularly, to a compact liquid crystal display device with an enlarged display region by reducing the frame region.

Generally, the liquid crystal display device includes a TFT substrate (first substrate) having pixel electrodes and thin film transistors (TFT) formed in a matrix, and a counter substrate (second substrate) having color filters and the like disposed at positions corresponding to the pixel electrodes of the TFT substrate. The liquid crystal is interposed between the TFT substrate and the counter substrate. Images are formed by controlling light transmittance of the liquid crystal molecules for each pixel.

The liquid crystal display device which may be formed into a thin and light-weight structure has been widely used for manufacturing the compact display device of a mobile phone. Since the liquid crystal cannot emit light by itself, the backlight is disposed on the back surface of the liquid crystal display panel. The liquid crystal display device of the mobile phone or the like employs an LED (Light Emitting Diode) as the light source for the backlight. The LED is disposed on the side surface of the light guide plate, and various kinds of optical sheets are provided on the light guide plate. Those optical components are accommodated inside the mold to constitute the backlight.

The optical sheet is thin and easily deformable. When such sheet that constitutes the backlight is bonded to foe fixed to the liquid crystal display panel and the mold, it will be deformed under thermal expansion. JP-A-2006-184656 discloses that the optical sheet is fixed without using the adhesive for preventing strain in the image owing to the aforementioned deformation of the optical sheet.

If the optical sheet is not fixed with the adhesive, the optical sheet will displace to cause the damage due to abrasion between the optical sheets, or between the optical sheet and the light guide plate. JP-A-2005-99461 discloses the structure having a tab formed outside the optical sheet, and bonded to be fixed so as to prevent displacement of the optical sheet.

The demand for increasing the display region of the compact liquid crystal display device of the mobile phone while keeping the small outer shape has been increasingly growing. The increased display region while keeping the small outer shape may reduce the so-called frame region. When the screen is viewed from the oblique direction, such device may cause the problem regarded as negligible for the generally employed product.

FIG. 7 is a sectional view representing a problem which occurs in the generally employed liquid crystal display device. As FIG. 7 shows, a counter substrate 200 is disposed on a TFT substrate 100, and a liquid crystal is interposed between the TFT substrate 100 and the counter substrate 200. A lower polarizing plate 101 is bonded to the lower surface of the TFT substrate 100, and an upper polarizing plate 201 is bonded to the upper surface of the counter substrate 200. The TFT substrate 100, the counter substrate 200, the lower polarizing plate 101 and the upper polarizing plate 201 constitute a liquid crystal display panel 500.

A backlight 600 is provided below the liquid crystal display panel 500. The backlight 600 includes a light guide plate 20 disposed inside a mold 10, and a lower diffusion sheet 30, a lower prism sheet 40 and an upper prism sheet 50 which are provided on the light guide plate. Additionally, an upper diffusion sheet may be added as the optical sheet. Furthermore, LEDs are provided on the side surface of the light guide plate 20, and a reflection sheet is provided below the light guide plate 20, which are not shown in FIG. 7.

The lower polarizing plate 101 of the liquid crystal display panel 500 is bonded to the mold 10 with an adhesive 80. The optical sheet is fitted with a recess of the mold 10 so as to be disposed on the light guide plate 20. The inner dimension of the mold 10 is larger than that of the optical sheet so as to be disposed in the recess of the mold 10. A predetermined gap 11 is formed between the optical sheets and the inner wall of the mold 10.

The liquid crystal display panel 500 includes a display region 300 and a frame region 400. Referring to the structure shown in FIG. 7, when the liquid crystal display panel 500 is viewed from the oblique direction, edges of the optical sheets (area designated with A in FIG. 7) at an end part of the display region 300 is visually recognized. The edges are visually recognized as an emission line, resulting in an unnatural image.

In order to cope with the above-described problem, the optical sheet is enlarged so that the edge of the optical sheet is made outwardly apart from the end part of the display region 300 of the liquid crystal display panel 500 as illustrated in FIG. 8. FIG. 8 is substantially the same as FIG. 7 except that sizes of the optical sheet, and the recess of the mold 10 for accommodating the optical sheet are increased. As FIG. 8 shows, the edge of the optical sheet is outwardly moved from the end part of the display region 300. Therefore, the edge of the optical sheet is not visually recognized when the screen is viewed from the oblique direction, and the emission line due to the edge of the optical sheet is invisible.

Referring to the structure illustrated in FIG. 8, the size of the recess of the light guide plate 20 has to be increased for accommodating the optical sheet, with the increased size. This may reduce the overlapped area between the upper surface of the mold 10 and the lower polarizing plate 101 of the liquid crystal display panel. 500. That is, the area for bonding the mold 10 and the liquid crystal display panel 500 (the area designated with 55 of FIG. 8) is reduced, thus deteriorating the bond strength. If a shock is applied to the liquid crystal display device, the aforementioned structure may cause the risk of separation of the liquid crystal display panel 500 from the mold 10.

The present invention provides the liquid crystal display device with the reduced frame region 400, capable of preventing visual identification of the emission line due to the edge of the optical sheet without deteriorating resistance against the mechanical damage when the screen is viewed from the oblique direction.

The present, invention has been made to solve the aforementioned problem, and provides the following advantages.
(1) A liquid crystal display device includes a liquid crystal display panel and a backlight. The backlight includes a light guide plate, a mold for accommodating the light guide plate, and a plurality of optical sheets disposed on the light guide plate. The mold has an upper surface which faces the liquid crystal display panel. Among the optical sheets, at least the optical sheet that is the closest to the liquid crystal display panel has a part which faces the upper surface of the mold. The liquid crystal display panel is bonded to the mold via the part which faces the upper surface of the mold,
(2) A liquid crystal display device includes a liquid crystal display panel with a first substrate and a second substrate opposite the first substrate, having a first polarizing plate bonded to the first substrate and a second polarizing plate bonded to the second substrate. A backlight is disposed close to the first substrate of the liquid crystal display panel. The backlight includes a light guide plate, a mold for accommodating the light guide plate, and a plurality of optical sheets disposed on the light guide plate. Among the optical sheets, at least the optical sheet that is the closest to the liquid crystal display panel includes a first region positioned farther to the outside than an end part of the light guide plate. The first polarizing plate is bonded to the mold via the first region.

According to the present invention, among the optical sheets that constitute the backlight together with the light guide plate, at least the one as the uppermost layer has a larger size. Then the liquid crystal display panel and the mold of the backlight are bonded via the aforementioned optical sheet. This makes it possible to prevent, visual identification of the emission line due to the edge of the optical sheet when the screen is viewed from the oblique direction. It is possible to have a sufficient area for bonding the liquid crystal display panel and the mold. This makes it possible to prevent separation of the liquid crystal display panel from the mold of the backlight.

### BRIEF DESCRIPTION OF THE DRAWINGS

FIG. 1 is an exploded perspective view of a liquid crystal display device;

FIG. 2 is a sectional view of a first example;

FIG. 3 is a sectional view of a second example;

FIG. 4 is a sectional view of a third example;

FIG. 5 is a sectional view of a fourth example;

FIG. 6 is an exploded perspective view of optical sheets;

FIG. 7 is a sectional view of a generally employed liquid crystal display device; and

FIG. 8 is a sectional view of another generally employed liquid crystal display device.

### DETAILED DESCRIPTION OF PREFERRED EMBODIMENTS

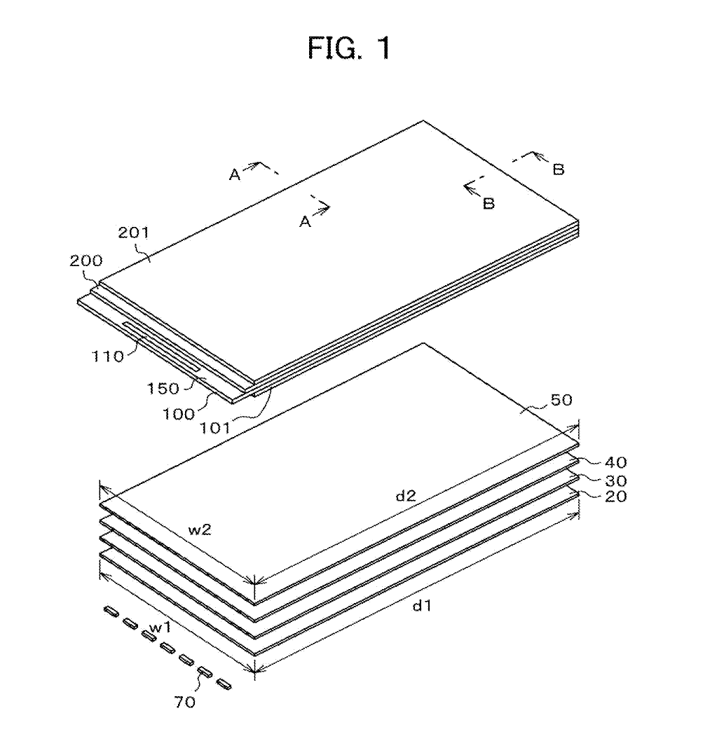

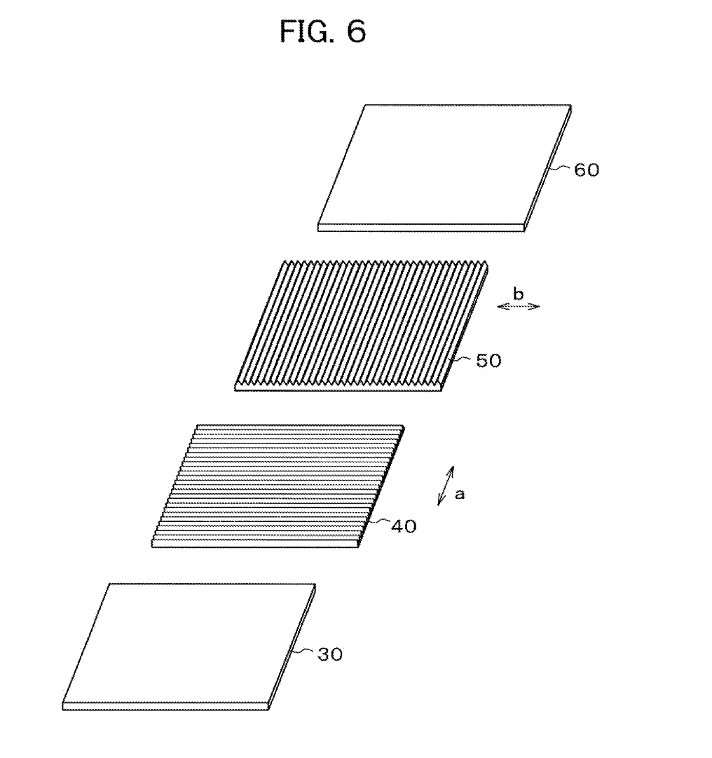

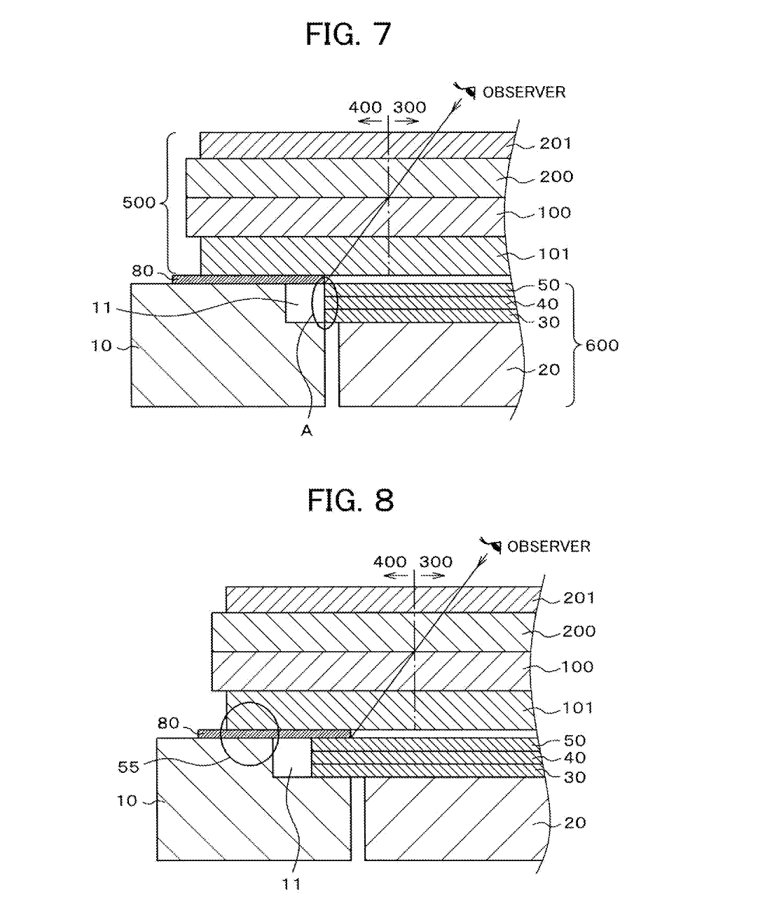

Prior to the explanation of examples according to the present invention, functions of the optical sheets used for the present invention will be described. FIG. 6 is a perspective view illustrating the respective optical sheets. Referring to FIG. 6, the lowermost layer is a lower diffusion sheet 30. The light radiated from the light guide plate 20 to the liquid crystal display panel has unevenness in brightness, for example, the light near LEDs 70 (shown in FIG. 1) is relatively bright, and the light at the location apart from the LEDs 70, or between the LEDs 70 is relatively dark. The lower diffusion sheet 30 serves to moderate the unevenness in brightness as described above so as to form the backlight with uniform luminance.

A lower prism sheet 40 is provided on the lower diffusion sheet 30. The lower prism sheet 40 has laterally extending prisms each with a triangular cross-section, which are longitudinally arranged as shown in FIG. 6. A pitch between the respective prisms is approximately 50 μm. The lower prism sheet 40 serves to direct the light that is likely to spread in the direction a to the vertical direction of the lower prism sheet 40 so as to improve the light utilization efficiency.

An upper prism sheet 50 is provided on the lower prism sheet 40. The upper prism sheet 50 has longitudinally extending prisms each with a triangular cross-section, which are laterally arranged as shown in FIG. 6. A pitch between the respective prisms is approximately 50 μm. The upper prism sheet 50 serves to direct the light that is likely to spread in the direction, b to the vertical direction of the upper prism sheet 50 so as to improve the light utilization efficiency.

Referring to FIG. 6, an upper diffusion sheet 60 is provided on the upper prism sheet 50. The upper diffusion sheet 60 serves to suppress generation of moiré on the screen of the liquid crystal display device. That is, brightness of the light radiated from the lower prism sheet 40 or the upper prism sheet 50 microscopically changes in a cycle in accordance with the prism pitch.

Meanwhile, the TFT substrate 100 of the liquid crystal display panel has scanning lines which laterally extend, and are longitudinally arranged. This may cause a part which transmits the light periodically in the longitudinal direction, and another part which shields the light dependent on the scanning line. The TFT substrate 100 of the liquid crystal display panel has video signal lines which longitudinally extend, and are laterally arranged. This may cause a part which laterally transmits the light periodically, and another part which shields the light dependent on the video signal line.

There may be an optical interference between the light that has transmitted through the lower prism sheet. 40 and the upper prism sheet 50, and the TFT substrate 100 of the liquid crystal display panel, thus generating the moiré. The upper diffusion sheet 60 moderates irregularity of the light intensity that has transmitted through the prism sheet so as to reduce the interference between the scanning line or the video signal line formed by the TFT substrate 100, and the prism pitch of the lower prism sheet 40 or the upper prism sheet 50, thus suppressing generation of the moiré. If the problem caused by the moiré is negligible, the upper diffusion sheet 60 may be omitted.

The present invention will be described in detail in reference to the following examples.

### First Example

FIG. 1 is an exploded perspective view illustrating the liquid crystal display panel and the backlight of the liquid crystal display device according to the example. FIG. 1 omits a mold on which the liquid crystal display panel is disposed for accommodating the backlight. Referring to FIG. 1, the counter substrate 200 (second substrate) is bonded to the TFT substrate 100 (first substrate). A not shown liquid crystal is interposed between the TFT substrate 100 and the counter substrate 200. The TFT substrate 100 is larger than the counter substrate 200, and an extended part of the TFT substrate 100 becomes a terminal portion 150 on which an IC driver 110 is disposed. A lower polarizing plate 101 is bonded to the lower surface of the TFT substrate 100, and an upper polarizing plate 201 is bonded to the upper surface of the counter substrate 200.

Referring to FIG. 1, the backlight is disposed on the back surface of the liquid crystal display panel. A plurality of LEDs 70 serving as the light source are provided on the side surface of the light guide plate 20, and the LEDs 70 constitute the backlight of side light type. A reflection sheet not shown is provided below the light guide plate 20. The lower diffusion sheet 30, the lower prism sheet 40, and the upper prism sheet 50 are sequentially placed in this order on the light guide plate 20. Referring to FIG. 1, the upper diffusion sheet is not used.

As FIG. 1 represents the feature of this example, a short side w2 of the optical sheet, that is, the lower diffusion sheet 30, the lower prism sheet 40, and the upper prism sheet 50, is longer than a short side w1 of the light guide plate 20. Referring to FIG. 1, a long side d1 of the light guide plate 20 is the same as a long side d2 of the optical, sheet, for example, the upper prism sheet 50. However, there may be the case where the long side d2 of the optical sheet is set to be longer than the long side d1 of the light guide plate.

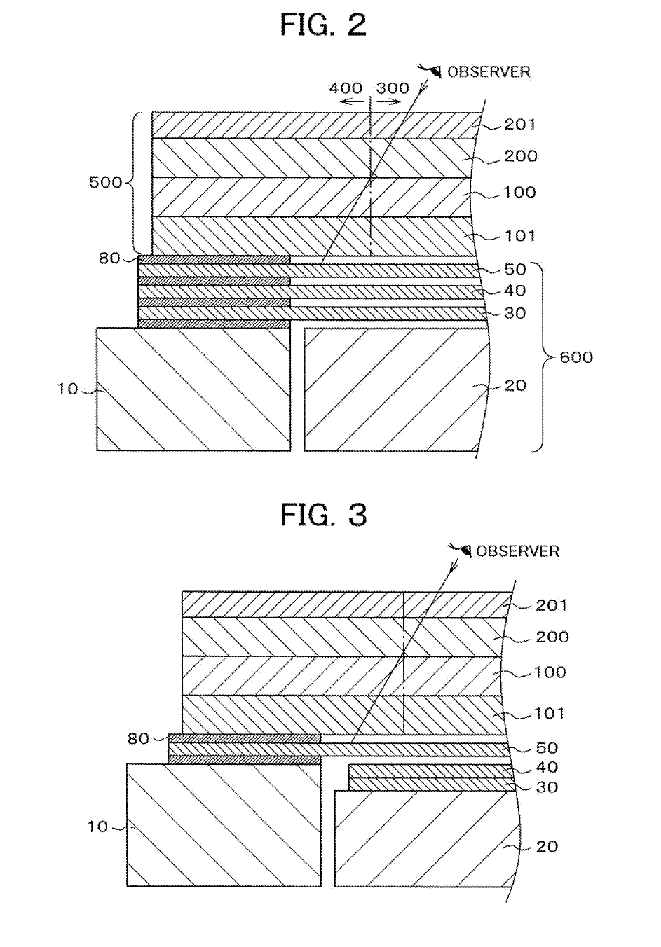

FIG. 2 is a sectional view taken along line A-A of FIG. 1, which represents that the backlight 600 including the respective optical sheets, the light guide plate and the mold is provided on the back surface of the liquid crystal display panel 500. Referring to FIG. 2, the light guide plate 20 is accommodated in the mold 10, and the lower diffusion sheet 30, the lower prism sheet 40 and the upper prism sheet 50 are bonded to the upper surface of the mold 10 with the adhesive 80. The liquid crystal display panel 500 is bonded to the upper prism sheet 50 as the uppermost, layer with the adhesive 80.

As the feature of this example, the liquid crystal display panel 500 is fixed to the mold 10 with the adhesive 80 via the three optical sheets. This structure allows the emission line due to the edge of the optical sheet to be invisible even when the end part of the screen is viewed from the oblique direction, as shown in FIG. 2. Accordingly, the image displayed on the screen appears natural even when the screen is viewed from the oblique direction.

In spite of the small frame region 400, it is possible to provide sufficient areas for bonding the liquid crystal display panel 500 to the upper prism sheet 50, and the lower diffusion sheet 30 to the mold 10, thus retaining sufficient shock resistance between the liquid crystal display panel 500 and the optical sheet, and between the optical sheet and the mold 10. As FIG. 2 shows, the short side (w2 of FIG. 1) of the optical sheet is longer than the short side of the light guide plate 20 (w1 of FIG. 1).

Referring to FIG. 2, edges of the upper prism sheet 50, the lower prism sheet 40, and the lower diffusion sheet 30 extend outward from the end part of the light guide plate 20. The edges of those optical sheets also extend outward from the end part of the lower polarizing plate 101.

The short side of the respective optical sheets is longer than that of the lower polarizing plate 101 of the liquid crystal display panel 500. The short side of the respective optical sheets may be the same as that of the lower polarizing plate 101 of the liquid crystal display panel 500. In bonding of the liquid crystal display panel 500 onto the optical sheet, there is a possibility of causing the positional displacement. It is therefore preferable to set the side of the respective optical sheets to be larger than that of the lower polarizing plate 101 of the liquid crystal display panel 500 so as to ensure a margin of the bonding area.

Referring to FIG. 2, the thickness of the lower diffusion sheet 30 is 30 μm, each thickness of the lower prism sheet 40 and the upper prism sheet 50 is 60 μm, and the thickness of the adhesive 80 is approximately 20 μm. A double-sided adhesive tape with shielding property may be employed as the adhesive 80. Each thickness of the TFT substrate 100 and the counter substrate 200 of the liquid crystal display panel 500 shown in FIG. 2 is set to 0.2 mm, and each thickness of the upper polarizing plate 201 and the lower polarizing plate 101 is set to 0.13 mm, respectively.

This example is configured to prevent generation of the emission line due to the edge of the optical sheet around the screen viewed from the oblique direction. It is also possible to ensure sufficient area for bonding the liquid crystal display panel 500 to the mold 10 via the optical sheets with the adhesive 80, and to prevent separation of the liquid crystal display panel 500 from the backlight such as the mold 10.

### Second Example

FIG. 3 is a sectional view taken along line A-A of FIG. 1, representing a second example according to the present invention, to which the mold 10 is added. FIG. 3 is substantially the same as FIG. 2 representing the first example except that only the upper prism sheet 50 as the uppermost layer is longer than the light guide plate 20. Referring to FIG. 3, the upper prism sheet 50 extends over the upper surface of the mold 10 and bonded thereto with the adhesive 80. The upper prism sheet 50 is further bonded to the lower polarizing plate 101 of the liquid crystal display panel with the adhesive 80.

Referring to FIG. 3, the upper prism sheet 50 extends over the upper surface of the mold 10 so that the edge of the upper prism sheet 50 is invisible even when the screen is viewed from the oblique direction. This makes it possible to prevent generation of the emission line due to the edge of the upper prism sheet 50. The lower prism sheet 40 and the lower diffusion sheet 30 are below the upper prism sheet 50, and accordingly, they are concealed thereby. Normally, the emission line due to the edges of those sheets is invisible as well.

As FIG. 3 shows, the upper prism sheet 50 extends over the upper surface of the mold 10. This makes it possible to provide a sufficient area for bonding the sheet to the mold 10, and the sheet to the lower polarizing plate 101 of the liquid crystal display panel, and further to prevent separation of the liquid crystal display panel from the backlight such as the mold 10 under influence of a shock.

Any other shape and size of the upper prism sheet 50 shown in FIG. 3 are the same as those of the optical sheet as described in the first example. In other words, as shown in FIG. 3, the edge of the upper prism sheet 50 extends outward from the end part of the light, guide plate 20, and further extends outward from the end part of the lower polarizing plate 101 of the liquid crystal display panel. Edges of the lower prism sheet 40 and the lower diffusion sheet 30 are located at the same position as or on the inward side of the end part of the light guide plate 20.

Specifically, the short side of the upper prism sheet 50 is longer than that of the light guide plate 20, and also longer than that of the lower polarizing plate 101 of the liquid crystal display panel. Meanwhile, each short side of the lower prism sheet 40 and the lower diffusion sheet 30 is the same as or shorter than that of the light guide plate 20.

As FIG. 3 shows, the liquid crystal display panel is bonded to the mold 10 only via the upper prism sheet 50 as the uppermost layer, making it possible to reduce the thickness of the liquid crystal display device as a whole. In comparison with the structure shown in FIG. 2, the liquid crystal display panel may be made thin by the thickness of 130 μm as a sum of 60 μm of the lower prism, sheet, 30 μm of the lower diffusion sheet, and 40 μm of two layers of the adhesive as shown in FIG. 3. The structure shown in FIG. 3 ensures cost, reduction of the optical sheet because of reduced areas of the lower prism sheet 40 and the lower diffusion sheet 30 in comparison with the structure shown in FIG. 2.

### Third Example

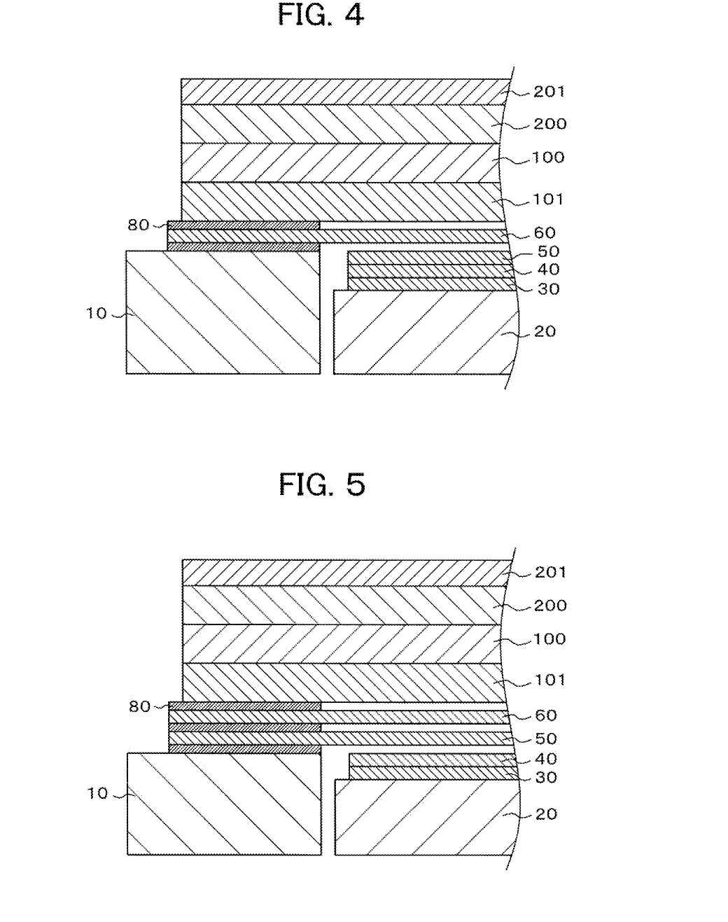

FIG. 4 is a sectional view taken along line A-A of FIG. 1, representing a third example according to the present invention, to which the mold 10 is added. FIG. 4 is substantially the same as FIG. 3 representing the second example except that an upper diffusion sheet 60 is added onto the upper prism sheet 50, that is, four optical sheets are used. The respective functions of the lower diffusion sheet 30, the lower prism sheet 40, the upper prism sheet 50 and the upper diffusion sheet 60 are the same as those described above.

In this example using the four optical sheets, the lower polarizing plate 101 of the liquid crystal display panel is bonded to the mold 10 only via the upper diffusion sheet 60 as the uppermost layer with the adhesive 80. Therefore, the thickness of the liquid crystal display device as a whole is smaller than the second example shown in FIG. 3. For example, the upper diffusion sheet 60 has the thickness of 30 μm which is smaller than the thickness of the upper prism sheet 50 of 60 μm.

Referring to FIG. 4, the upper diffusion sheet 60 extends over the upper surface of the mold 10. The edge of the upper diffusion sheet 60 is invisible even when the screen is viewed from the oblique direction. This makes it possible to prevent generation of the emission line due to the edge of the upper diffusion sheet 60. The upper prism sheet 50, the lower prism sheet 40 and the lower diffusion sheet 30 are below the upper diffusion sheet 60, and accordingly, they are concealed thereby. Normally, the emission line due to the edges of those sheets is also invisible.

As FIG. 4 shows, the upper diffusion sheet 60 extends over the upper surface of the mold 10. This makes it possible to provide a sufficient area for bonding the mold 10 and the lower polarizing plate 101 of the liquid crystal display panel, and further to prevent separation of the liquid crystal display panel from the backlight such as the mold 10 under influence of a shock.

Any other shape and size of the upper diffusion sheet 60 shown in FIG. 4 are the same as those of the optical sheet as described in the first example. In other words, as shown in FIG. 4, the edge of the upper diffusion sheet 60 extends outward from the end part of the light guide plate 20, and further extends outward from the end part of the lower polarizing plate 101 of the liquid crystal display panel. Edges of the upper prism sheet 50, the lower prism sheet 40 and the lower diffusion sheet 30 are located at the same position as or on the inward side of the end part of the light guide plate 20.

Specifically, the short side of the upper diffusion sheet 60 is longer than that of the light guide plate 20, and also longer than that of the lower polarizing plate 101 of the liquid crystal display panel. Meanwhile, each short side of the upper prism sheet 50, the lower prism sheet 40 and the lower diffusion sheet 30 is the same as or shorter than that of the light guide plate 20,

### Fourth Example

FIG. 5 is a sectional view taken along line A-A of FIG. 1, representing a fourth example according to the present invention, to which the mold 10 is added. Like the third example, this example is configured to employ four optical sheets. FIG. 5 is substantially the same as FIG. 4 representing the third example except that the lower polarizing plate 101 of the liquid crystal display panel is bonded to the mold 10 via the upper diffusion sheet 60 and the upper prism sheet 50 with the adhesive 80.

The structure shown in FIG. 4 has the upper diffusion sheet 60 as thin as 30 μm. When the screen is viewed from the oblique direction, the emission line may be observed because of the edge of the upper prism sheet 50 seen through in accordance with the haze value of the upper diffusion sheet 60 or the luminance of the light source. For preventing such problem, two optical sheets of the upper diffusion sheet 60 and the upper prism sheet 50 extend over the upper surface of the mold 10 so as to completely eliminate the effect of the edges of the optical sheets below, for example, the lower prism sheet 40 and the like.

Sizes and shapes of the upper diffusion sheet 60 and the upper prism sheet 50 as shown in FIG. 5 are the same as those explained with respect to the upper diffusion sheet 60 referring to FIG. 4. This example is capable of preventing generation of the emission line due to the edge of the optical sheet. The upper diffusion sheet 60 and the upper prism sheet 50 extend over the upper surface of the mold 10. This makes it possible to provide a sufficient area for bonding the mold 10 to the lower polarizing plate 101 of the liquid crystal display panel, and further to prevent separation of the liquid crystal display panel from the backlight such as the mold 10 under influence of a shock.

The relationship among the respective optical sheets, the lower polarizing plate of the liquid crystal display panel, and the light guide plate with respect to the short side of the liquid crystal display panel has been mainly explained in reference to the aforementioned first to the fourth examples. Especially the frame of the liquid crystal display device has a significantly decreased long side, and accordingly, the dimension in the short side direction is especially important. The mobile phone has been strongly demanded to reduce the short side of the liquid crystal display device.

The frame at the short side has also been demanded to be reduced. In this case, dimensions of the liquid crystal display panel and the optical components of the backlight with respect to the short side opposite the terminal portion become important. For solving this problem, the relationship between the optical sheet and the lower polarizing plate of the liquid crystal display panel or between the optical sheet and the mold is made in the similar way to the description explained in the first to the fourth examples with respect to the cross-section perpendicular to the short side, that is, the cross-section taken along line B-B of FIG. 1. The long side of the optical sheet, as the uppermost layer, is longer than that of the light guide plate.

Meanwhile, the terminal port ion exists on the short side of the liquid crystal display panel corresponding to the position where the LEDs are disposed. This makes it possible to sufficiently increase the overlapped area between the mold and the liquid crystal display panel. The optical sheet is widened outward from the display-region so as to prevent generation of the emission line due to the edge of the optical sheet.

What is claimed is:

1. A liquid crystal display device comprising a liquid crystal display panel and a backlight,
wherein the backlight includes a light guide plate, a mold which accommodates the light guide plate, and a plurality of optical sheets disposed on the light guide plate;
the mold has an upper surface which faces the liquid crystal display panel;
among the optical sheets, at least the optical sheet that is the closest to the liquid crystal display panel has a part which faces the upper surface of the mold; and
the liquid crystal display panel is bonded to the mold via the part which faces the upper surface of the mold.

2. The liquid crystal display device according to claim 1,
wherein the liquid crystal display panel and the optical sheet that is the closest to the liquid crystal display panel are bonded, and the upper surface of the mold and the optical sheet that is the closest to the upper surface are bonded with a double-sided adhesive tape, respectively; and
a whole region of the double-sided adhesive tape is overlapped with the upper surface of the mold in a planar view.

3. The liquid crystal display device according to claim 1,
wherein some of the optical sheets including the optical sheet that is the closest to the liquid crystal display panel have parts which face the upper surface of the mold; and
the liquid crystal display panel is bonded to the mold via the parts of some of the optical sheets, which face the upper surface of the mold.

4. The liquid crystal display device according to claim 3,
wherein all the optical sheets have parts which face the upper surface of the mold; and
the liquid crystal display panel is bonded to the mold via the parts of all the optical sheets, which face the upper surface of the mold.

5. The liquid crystal display device according to claim 1, wherein the liquid crystal display panel is bonded to the mold only via the part of the optical sheet that is the closest to the liquid crystal display panel, which faces the upper surface of the mold.

6. The liquid crystal display device according to claim 1,
wherein the optical sheets include a first diffusion sheet, a first prism sheet, and a second prism sheet disposed closer to the liquid crystal display panel than the first prism sheet; and
the second prism sheet is the closest to the liquid crystal display panel.

7. The liquid crystal display device according to claim 1,
wherein the optical sheets include a first diffusion sheet, a first prism sheet, a second prism sheet positioned closer to the liquid crystal display panel than the first prism sheet, and a second diffusion sheet positioned closer to the liquid crystal display panel than the first diffusion sheet; and
the second diffusion sheet is the closest to the liquid crystal display panel.

8. The liquid crystal display device according to claim 1,
wherein, the backlight has a light source which faces a first side of the light guide plate; and
the part which faces the upper surface of the mold is positioned close to a second side of the light guide plate, which is different from the first side.

9. A liquid crystal display device including a liquid crystal display panel with a first substrate and a second substrate opposite the first substrate, having a first polarizing plate bonded to the first substrate and a second polarizing plate bonded to the second substrate, and a backlight disposed close to the first substrate of the liquid crystal display panel,
wherein the backlight includes a light guide plate, a mold which accommodates the light guide plate, and a plurality of optical sheets disposed on the light guide plate;
among the optical sheets, at least the optical sheet that is the closest to the liquid crystal display panel includes a first region positioned farther to the outside than an end part of the light guide plate; and
the first polarizing plate is bonded to the mold via the first region.

10. The liquid crystal display device according to claim 9, wherein an edge of the first region is positioned farther to the outside than an end part of the first polarizing plate.

11. The liquid crystal display device according to claim 9,
wherein the first polarizing plate and the first, region of the optical sheet that is the closest to the liquid crystal display panel are bonded, and the mold and the first region of the optical sheet that is the closest to the mold among the optical sheets are bonded with a double-sided adhesive tape, respectively; and
a whole region of the double-sided adhesive tape is overlapped with the first region in a planar view.

12. The liquid crystal display device according to claim 9,
wherein some of the optical sheets including the optical sheet that is the closest to the liquid crystal display panel have the first regions; and
the first polarizing plate is bonded to the mold via the first regions of some of the optical sheets.

13. The liquid crystal display device according to claim 12,
wherein all the optical sheets have the first regions; and
the first polarizing plate is bonded to the mold via the first regions of all the optical sheets.

14. The liquid crystal display device according to claim 9, wherein the first polarizing plate is bonded to the mold only via a part of the optical sheet that is the closest to the liquid crystal display panel, which faces the first region.

15. The liquid crystal display device according to claim 9,
wherein the optical sheets include a first diffusion sheet, a first prism sheet, and a second prism sheet positioned closer to the liquid crystal display panel than the first prism sheet; and
the second prism sheet is the closest to the liquid crystal display panel.

16. The liquid crystal display device according to claim 9,
wherein the optical sheets include a first diffusion sheet, a first prism sheet, a second prism sheet positioned closer to the liquid crystal display panel than the first prism sheet, and a second diffusion sheet positioned closer to the liquid crystal display panel than the first diffusion sheet; and
the second diffusion sheet is the closest to the liquid crystal display panel.

17. The liquid crystal display device according to claim 9,
wherein the backlight has a light source which faces a first side of the light guide plate; and
the first region is positioned close to a second side of the light guide plate, which is different from the first side.
